(19) United States
(12) Patent Application Publication
(10) Pub. No.: US 2016/0086167 A1
(43) Pub. Date: Mar. 24, 2016

(54) SYSTEM AND METHOD FOR ADMINISTERING A VALUE VAULT

(71) Applicant: PAYAL, INC., San Jose, CA (US)

(72) Inventor: Vishwanath Shastry, Mountain View, CA (US)

(21) Appl. No.: 14/954,964

(22) Filed: Nov. 30, 2015

Related U.S. Application Data
(63) Continuation of application No. 11/964,232, filed on Dec. 26, 2007.

(51) Int. Cl. G06Q 20/36; G06Q 20/32; G06Q 20/34

(52) U.S. Cl. CPC G06Q 20/363; G06Q 20/354; G06Q 20/322

(57) ABSTRACT

A system and method for administering a value vault is described herein. In one embodiment, the system includes a communication interface; a database having stored therein information regarding a plurality of value programs associated with a plurality of merchants; and a system configured to receive a request from one of the plurality of merchants via the communication interface, and make available at least one or more of the value programs associated with the merchants to obtain the item.

### CROSS-REFERENCE TO RELATED APPLICATION

This application is a continuation of and claims priority to U.S. patent application Ser. No. 11/964,232, filed Dec. 26, 2007, which is incorporated herein by reference in its entirety.

### BACKGROUND

1. Field of the Invention

The present disclosure relates generally to a system and method for administering a value vault (database) for use with, among other things, gift cards and other value programs.

2. Related Art

In direct (face-to-face) or online financial transactions customers search for and purchase products and/or services from a merchant. In the case of online shopping, transactions are conducted through electronic communications with online merchants over electronic networks, such as the Internet. Customers will typically carry any number of credit cards or other forms of payment to satisfy a variety of accounting purposes including one or more cards for business related purchases, one or more cards for personal related purchases, as well as gift cards or gift certificates, and loyalty account cards, and similar value programs, to name a few. Accordingly, in addition to being cumbersome and inconvenient, carrying or being in possession of many cards at one time substantially increases the risk of one or more of the cards being lost or stolen. There is also the possibility that some forms of carried payment are not accepted by the merchant (e.g. American Express, personal checks, etc.).

Furthermore, having to make an on-the-spot decision as to which payment method to use including the determination of availability and value of gift cards, credits, coupons, loyalty awards, etc., associated with a particular program and/or merchant for use toward the purchase of an item, may be, among other things, difficult, inconvenient, time-consuming, and confusing for many individuals.

For example, in one scenario, a customer may have selected an item for purchase either online or directly from the merchant as when shopping from a computer or at a mall. The customer then proceeds to checkout where the customer makes a determination of which funding instrument to utilize for the purchase of the item. If the merchant provides value programs such as awards programs, or other incentives to attract or retain customers, the customer may ask if they have any credit in such a value program that may be redeemed or applied to reduce to the purchase price of the selected item. In many circumstances, the merchant may be able to make a determination of value program enrollment, but is unable to determine program value or credit, and even more unlikely to be able to apply the credit to the item price at the time of purchase.

Likewise, the customer may search their wallet or purse for any coupons, gift cards/certificates, or the like that may be utilized towards the purchase price of the item. However, more often than not, the customer cannot find a particular merchant's gift card or unaware of any credits, gift cards, or similar type value items associated with a particular merchant they may possess that can be used in consideration of the item for purchase.

Accordingly, there exists a need for a system and method for administering a value vault (database) for use with, among other things, gift cards and other value programs to facilitate a financial transaction.

### SUMMARY

For purposes of summarizing the disclosure, exemplary embodiments of a system and method for administering a value vault (database) for use with, among other things, gift cards and other value programs to facilitate a financial transaction have been described herein.

In one embodiment, a method of making available one or more value programs associated with a merchant during the purchase of an item by automatically presenting the one or more value programs during the purchase transaction is disclosed.

In another embodiment, a system of making available one or more value programs associated with a merchant during the purchase of an item comprises a communication interface; a database having stored therein information regarding a plurality of value programs associated with a plurality of merchants; and a payment provider system configured to receive a purchase request from one of the plurality of merchants via the communication interface, and make available at least one or more of the value programs associated with the merchants during the purchase of an item.

In still another embodiment, a network payment provider system having a database having stored therein information regarding a plurality of value programs associated with a plurality of merchants, the payment provider system configured to facilitate one of trading, auctioning, or buying and selling of the merchant associated value programs is disclosed.

In another embodiment, a network payment provider system having a database having stored therein information regarding a plurality of value programs associated with a plurality of merchants, the payment processing device configured to receive a purchase request for one or more items, process the purchase request, and automatically make available one or more value programs of the plurality of value programs associated with one merchant of the plurality of merchants during purchase of the item is disclosed.

These and other embodiments will become readily apparent to those skilled in the art from the following detailed description of the various embodiments having reference to the attached figures, the invention not being limited to any particular preferred embodiment(s) disclosed.

### BRIEF DESCRIPTION OF THE DRAWINGS

FIG. 1 shows a block diagram of a known networked system configured to facilitate an online financial transaction.

FIG. 2 shows a block diagram of a networked system including a universal funding card and further having a value vault (database) for administering, among other things, gift cards and other value programs for use in facilitating a financial transaction in accordance with one embodiment.

FIG. 3 shows a block diagram of block diagram of a portion of the networked system of FIG. 2, including the value vault for administering, among other things, gift cards and other value programs for use in facilitating a financial transaction in accordance with one embodiment.

FIG. 4 shows a method for administering a value vault for use in facilitating a financial transaction with reference to a user in accordance with one embodiment.

FIG. 5 shows a method for administering a value vault for use in facilitating a financial transaction with reference to a payment processor device or provider server in accordance with one embodiment.

Embodiments of the invention are understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Exemplary embodiments will now be described with references to the accompanying figures, wherein like reference numbers refer to like elements throughout. The terminology used in the description presented herein is not intended to be interpreted in any limited or restrictive manner simply because it is being utilized in conjunction with a detailed description of certain embodiments.

Embodiments of the present disclosure overcome the often difficult, inconvenient, time consuming, and indecisive nature of matters associated with the possession and/or use of multiple funding instruments for the real-time purchase of products and/or services by providing a single payment instrument (universal funding card), as well as, a system and method for administering a value vault (database) for, among other things, gift cards and other value programs to facilitate the financial transaction.

Embodiments of the present disclosure are described herein as they may relate to an electronic payment system environment. An electronic payment system is generally considered as any kind of network service that includes the exchange of money for goods or services. Such network payment system includes, for example, a credit and/or debit card processing system. For convenience, simplicity, and efficiency the present disclosure is primarily described relative to an online or web-based financial transaction. However, persons of ordinary skill in the art will understand that the teachings of the present disclosure apply equally to a financial transaction that occurs directly between a buyer and a merchant such as in a face-to-face transaction that may occur in department store or similar type business environment.

In one embodiment, the network may be implemented as a single network or a combination of multiple networks. For example, in various embodiments, the network may include the Internet and/one or more intranets, landline networks, wireless networks, and/or other appropriate types of communication networks. In another example, the network may comprise a wireless telecommunications network (e.g., cellular phone network) adapted to communicate with other communication networks, such as the Internet.

As disclosed herein, unless otherwise noted, the term “value vault” is a broad term generally considered to include, among other things, a database or similar medium for the acquisition, storage, manipulation, transfer, or otherwise management and administration of various types data or information associated with value programs including gift cards, as described below.

As used herein, unless otherwise noted, the term “value program” is a broad term generally considered to included, among other things, gifts cards or certificates; coupons; loyalty, cash back, and awards programs, and similar type incentive, promotional, and/or retention programs offer by a merchant such as airline miles and/or credit card points.

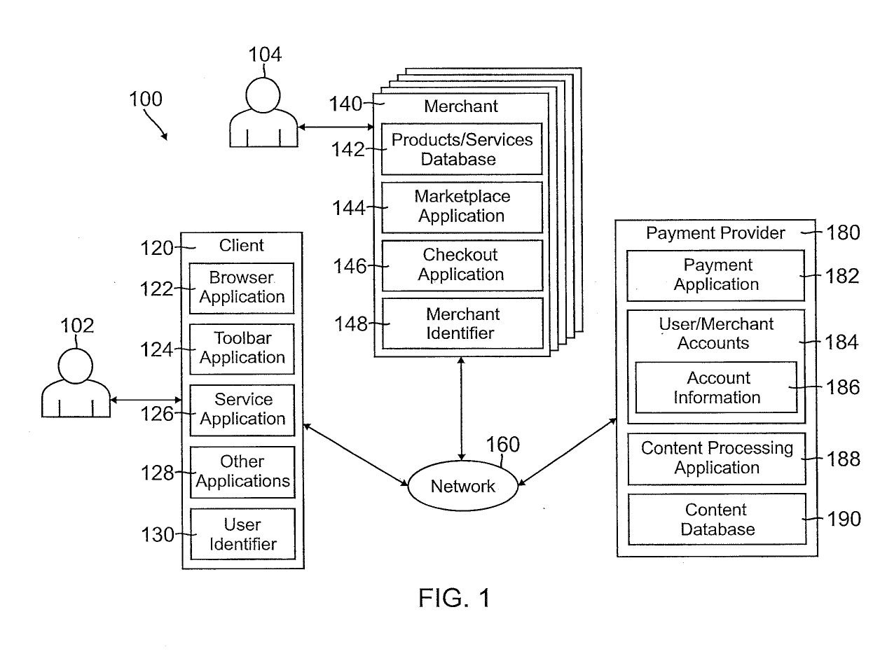

FIG. 1 shows one embodiment of a block diagram of a system 100 configured to facilitate financial transactions over a network 160. As shown in FIG. 1, system 100 includes at least one client system 120, one or more merchant systems 140, and at least one payment provider system 180 in communication over the network 160.

In one embodiment, the client system 120 may be implemented using any appropriate combination of hardware and/or software configured for wired and/or wireless communication over the network 160. For example, the client system 120 may be implemented as a personal computer of a user 102 (e.g., a purchaser, a client, a buyer, a customer) in communication with the network 160, such as the Internet. In other examples, the client system 120 may be implemented as a wireless telephone (e.g., cell phone), personal digital assistant (PDA), notebook computer, and/or various other generally known types of computing devices.

In one embodiment, the client system 120 may include one or more browser applications 122 which may be used, for example, to provide a user interface to permit the user 102 to browse information available over the network 160; one or more toolbar applications 124 displaying a graphical user interface (GUI) in connection with the browser application 122 to provide client-side processing for performing tasks in response to operations selected by the user 102

The service application 126 typically comprises a software program, such as the GUI, executable by a processor that is configured to interface and communicate with the one or more merchant systems 140 and the payment provider system 180 via the network 160. The service application 126 is configured to provide and display a payment mechanism, such an image or icon, on a display component (e.g., monitor) of the client system 120. The user 102 is able to access merchant websites 141 via merchant systems 140 to view and select items for gift purchase by communicating with the payment provider system 180.

The client system 120 may include other applications 128 as may be desired in particular embodiments to provide additional features available to the user 102. For example, such other applications 128 may include security applications for implementing client-side security features, programmatic client applications for interfacing with appropriate application programming interfaces (APIs) over the network 160 or various other types of generally known programs and/or applications.

The client system 120 may include one or more user identifiers 130, which may be implemented, for example, as operating system registry entries, cookies associated with the browser application 122, identifiers associated with hardware of the client system 120, or various other appropriate identifiers. The user identifier 130 may include attributes related to the user, such as personal information and banking information. In various implementations, the user identifier 130 may be passed with a user purchase request to the payment provider system 180, and the user identifier 130 may be used by the payment provider system 180 to associate the user 102 with a particular user account maintained by the payment provider system 180.

As shown in FIG. 1, one or more merchant systems 140 are maintained by merchants 104 offering various items (products and/or services) in exchange for financial payment or other consideration to be received from users, such as user 102, over the network 160. In this regard, each one of the one or more merchant systems 140 may include a database 142 for identifying available products and/or services, which may be made available to the client system 120 for viewing and purchase by the user 102. Accordingly, each of the merchant systems 140 may include a marketplace application 144 configured to provide information over the network 160 to the browser application 122 of the client system 120. For example, the user 102 may interact with the marketplace application 144 through the browser application 122 over the network 160 to search and view various items, products and/or services identified in the database 142.

Each of the one or more merchant systems 140 may include a checkout application 146 configured to accept payment information from the user 102 and/or from the payment provider system server 180 over the network 160 to facilitate online transactions of products and/or services identified by the marketplace application 144.

Each of the one or more merchant systems 140 may include one or more merchant identifiers 148, which may be included as part of the one or more items made available for purchase so that a particular item may be associated with a particular merchant 104. The merchant identifier 148 may include attributes related to the merchant 104, such as business and banking information. In various implementations, the merchant identifier 148 may be passed with a user purchase request to the payment provider system 180 when the user 102 selects an item for purchase and processing, and the merchant identifier 148 may be used by the payment provider system server 180 to associate a particular item purchased with a particular merchant account maintained by the payment provider system 180.

Each of the one or more merchants 104 having a related merchant system 140 may need to establish a merchant account 184 with the payment provider system 180 so that the payment provider system 180 is able to process transactions having items offered for purchase by the merchants 104. When establishing a merchant account 184, each of the one or more merchants 104 may need to provide business information, such as name, address, phone number, etc., and financial information, such as banking information, merchant account information, credit card information, payment processing information, etc.

Each of the one or more merchant systems 140 may be associated with a particular website 141 (e.g., a link, such as a URL (Uniform Resource Locator) to an IP (Internet Protocol) address). In this regard, the payment provider system 180 may optionally redirect the browser application 122 to an appropriate webpage and/or merchant site 141 of the merchant system 140 to facilitate purchase of a corresponding item made available from at least one of the merchant systems 140.

The payment provider system 180 may be maintained, for example, by an online payment service provider, which may provide payment processing for online transactions on behalf of the user 102 to an operator of the merchant system 140. In this regard, the payment provider system 180 includes one or more payment applications 182, which may be configured to interact with the client system 120 and/or each of the merchant systems 140 over the network 160 to facilitate the purchase of items by the user 102 from the merchant system 140.

The payment provider system 180 may be configured to maintain a plurality of user and merchant accounts 184, each of which may include account information 186 associated with individual users, including the user 102, and the one or more merchants 104 associated with the merchant systems 140. For example, account information 186 may include private financial information of user 102 and merchants 104, such as one or more account numbers, passwords, credit card information, banking information, or other types of financial information, which may be used to facilitate online transactions between the user 102 of the client system 120 and one or more merchants 104 associated with the merchant systems 140. As such, the payment application 182 may be configured to interact with the one or more merchant systems 140 on behalf of the user 102 during a transaction with checkout application 146 without requiring the user 102 to provide account information 186 directly to the merchant system 140. In various embodiments, the methods and systems described herein may be modified to accommodate users and/or merchants that may or may not be associated with at least one existing user account and/or merchant account, respectively.

In one method for conducting a client-side online financial transaction, the service application 126 may be installed and run on the client system 120 to allow the client system 120 to communicate with one or more of the merchant systems 140 via the network 160 select an item for purchase. The user 102 may run the browser application 122 on the client system 120 to access at least one merchant website 141 via a related merchant system 140 to search the accessed merchant website 141 and view one or more items for purchase.

Likewise, the service application 126 allows the client system 120 to further communicate with the payment provider system 180 to process online purchase requests for items selected for purchase and processing in a financial transaction.

As previously discussed, the user 102 may initiate a user purchase request by dragging and dropping an item 107 over an appropriate icon, which initiates the user purchase request and online financial transaction with the payment provider system 180. In this regard, the payment provider system 180 receives a purchase request from the user 102 via the client system 120.

Next, upon receiving the user purchase request, the payment provider system 180 verifies the user account information including user identification provider by user 102 in the user purchase request. For example, the user 102 may be prompted by the payment provider system 180 to provide user identification 186 or at least verify the user identification for a related user account 184 stored in payment provider system 180 so that funds may be deducted from the user account 184 for purchase of the item 107. Once proper user identification is provided and/or verified, the online purchase may be completed.

In this regard, the purchase request may include user information, merchant information, and selected item information embedded as arguments in an expression that are passed to the payment provider system 180. The user information may include user identifier information, the merchant information may include the merchant identifier information, and the selected item information may include one or more image attributes, including item identifier information, having dynamic arguments identifying the item and merchant providing the item.

Next, the payment provider system 180 may prompt the user 102 via, for example, a pop-up window, to verify the purchase request. For example, the payment provider system 180 may ask the user 102 to select a designated box to complete the purchase. Next, the payment provider system 180 completes the online transaction by deducting the amount of the purchase request from the user account 184 and crediting the amount of the purchase request to the merchant account 184.

It should be appreciated by those skilled in the art that more than one item may be selected prior to completing the online purchase. For example, a plurality of items may be selected and placed in a virtual shopping cart and then purchased in a single online transaction. Alternately, each item selected for purchase may be purchased separately without departing from the scope of the present disclosure.

The present disclosure addresses, among other things, the inconvenience of carrying or being in possession of many cards at one time and the substantial increased risk of one or more of the cards being lost or stolen by providing a universal funding card (UFC) having, among other things, a plurality of funding instruments associated with the card.

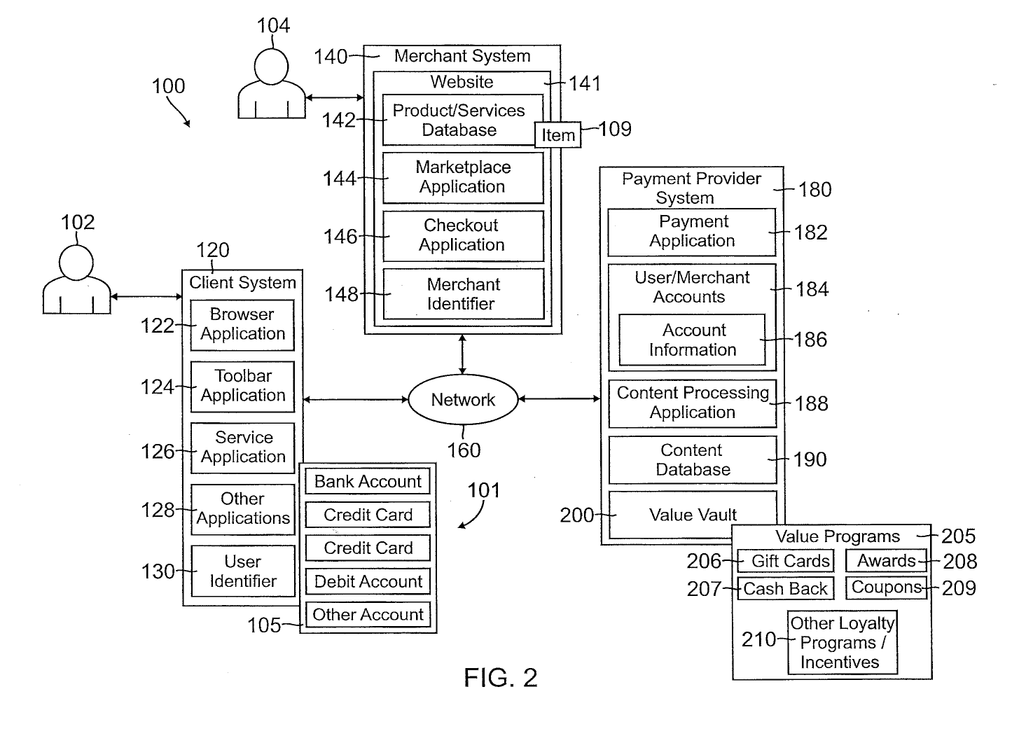

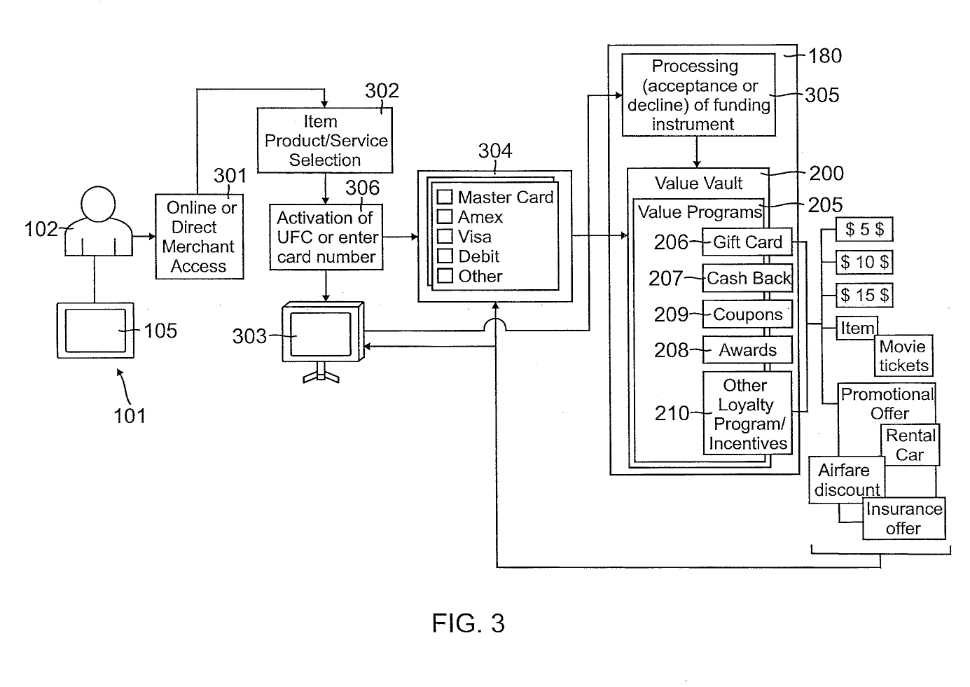

In one embodiment, as shown in FIG. 2 and explained in more detail with regard to FIG. 3, a user 102 is issued a universal funding card 101 that is configured to facilitate a product and/or service purchase. In this regard, information regarding multiple funding instruments 105 made available for access to the user 102 as well as user information may be embedded on one or more lines of the magnetic card strip found on the UFC 101. In a face-to-face transaction, the UFC 101 may be swiped, optically read, or have the information transmitted by use of an RFID chip at a point-of-sale terminal to communicate the information contained on the UFC 101 to the payment provider system 180. In return, the user 102 is provided with a choice of funding instruments 101 for purchase of the item. In the case of an online transaction, entering the universal funding card number at the merchant's website 141 redirects the user 102 to the payment provider system 180 where the user 102 is given a choice of funding instrument 105 for the financial transaction.

Funding instruments 105 made available to the user 102 for the purchase of an item 107 in a financial transaction may include, but are not limited to, a bank account, debit account, various credit card accounts, and/or other accounts such as a designated business or personal account. When one or more funding instruments 105 are selected at the time of purchase, the payment provider system 180 processes the selected funding instrument 105 as generally detailed above. Accordingly, the one or more funding instruments 105 are authorized; funds are cleared, settled, and distributed to the merchant's account 184; and debited from the user's account 184.

The present disclosure further addresses, among other things, the difficult, inconvenient, time-consuming, and confusing process for many individuals of determining the availability and value of gift cards and other value programs include credits; coupons; and cash back, awards, and other loyalty programs, incentives and/or promotions associated with a particular merchant for use toward the purchase of an item or other purposes as explained below.

In this regard, in one embodiment shown in FIG. 2, the payment provider system 180 includes a value vault (database) 200 configured to include value programs 205 such as those mentioned above, and information regarding the value programs 205. Various value programs 205 including program related information may be communicated or transferred to the value vault 205 from the merchant system 140 as a result of any number of reasons including user 102 purchasing frequency, amount, and/or habits, upcoming seasonal or holiday events, geographic location of the user 102, or for no apparent reason at all as may be the case with bulk or random value program 205 transmittals to the value vault 200.

Value program 205 information regarding gift cards 206 may include gift card type (product and/or service); original value and value remaining, if used toward a previous purchase; associated merchant or vendor identification; expiration date (if any); and similar data as may be required to facilitate management and administration or processing of the gift card 206 toward the purchase of an item. A plurality of such gift cards 206 associated with a plurality of merchants may be maintained by the payment provider system 180 within the value vault 200.

Similarly, information regarding coupons 209 including coupon type (product and/or service), coupon value, associated merchant or vendor identification, expiration date (if any), and similar data as may be required to facilitate management and administration or processing of the coupon 209 toward the purchase of an item may be stored in the value vault 200. A plurality of such coupons 209 associated with a plurality of merchants may be maintained by the payment provider system 180 within the value vault 200.

Information regarding cash back 207; awards 208; and other loyalty program 210, incentive, and/or promotional items associated with various merchants stored in the value vault 200 may include the total monies spend with a particular merchant to be used in computing a certain percentage of the total for cash back 207 to the user 102, gift items or other awards based on user spending, or the availability of promotional or incentive items that the user may accept or reject.

The payment provider system 180 may also provide for a translation or modification of assigned value for each value program. For example, the payment provider system 180 may know that a certain exchange rate exists between various value programs 205 and items 107 offered in the product/service database 142. These values could be adjusted to suit either the merchant 104 or the payment program provider 180, and may even be tailored to the user 102 (e.g. if the merchant 104 is eager to sell an item 107 and values the user's business, the merchant 104 may choose to adjust, for example, lower the rate, at which the a particular value program 205 (e.g. airline miles) was converted to value). In other words, the airline miles normally available to be redeemed at 5000 miles may be redeemed at 3000 miles.

Further in this regard, value programs 205 such as coupons having a relatively more defined cash value may be combined with value programs 205 such as loyalty programs (e.g., airline miles) to reduce the cost of an item for purchase. In this regard, the airline miles, if redeemed, may be designated to have a cash value of a certain amount that may be applied and/or used in combination with other value programs to the item for purchase.

In one embodiment, as generally shown in FIG. 3, the user 102 may access a merchant 301 either online or directly as in a face-to-face transaction to search and view items (products and/or services) 302 offered by the merchant 301 for purchase. The network connectivity, use of hardware, software include various browser, toolbar, marketplace, and payment applications as described relative to FIG. 1 and FIG. 2 is understood to apply to FIG. 3. Accordingly, for convenience and ease of explaining the subject matter disclosed, any further discussion of those topics may or may not be omitted.

Accordingly, the client system 120 may include one or more browser applications 122 which may be used to, for example, to provide a user interface to permit the user 102 to browse information available over the network 160. The client system 120 may include one or more toolbar applications 124, which may be used, for example, to provide client-side processing for performing tasks in response to operations selected by the user 102. In this regard, upon selection of an item(s) for purchase and activation 306 of the UFC 101 by entering the UFC 101 card number at the merchant site 141, or having information contained on the UFC 101 scanned magnetically or optically or transmitted via use of a RFID chip at the point-of-sale terminal, the user 102 may be presented with a plurality of funding instrument selections via an on screen menu 303 associated with a computer monitor as may occur with online access, or a touch pad screen 304 that may be associated with the point-of-sale terminal.

Funding instruments 105 made available to the user 102 for selection may include, but are not limited to, various credit cards including MasterCard®, Visa®, and American Express®, to name a few. In addition, individual bank or merchant cards, debit or deposit accounts, and similar type accounts may be made available to the user 102 for selection and processing when purchasing an item 302 in a financial transaction.

Alternatively, upon selection of an item 302 for purchase and activation of the UFC 101, a funding instrument 105 may be automatically selected by the payment provider system 180 for the user 102. For example, in this regard, the user 102 may be shopping with a merchant in which a merchant specific charge card has been issued to the user 102. Merchant specific information received by the payment provider system 180 upon activation of the UFC 101 from the merchant's website or point-or-sale terminal would facilitate retrieval of the corresponding merchant specific information from the payment provider system 180, and make available the corresponding merchant specific charge card to the user 102. At this point, the user 102 may accept use of the merchant specific charge card or reject the card and select an alternative funding instrument for purchase of the item 302.

In either scenario, upon user 102 selection of a funding instrument 105, the funding instrument 105 may be processed 305, as explained above, for acceptance or decline by the payment provider system 180 for use in the purchase of the item selected by the user 102.

In addition to the merchant specific information being made available to the payment provider system 180 for funding instrument acceptance or decline purposes 305, the merchant specific information may be linked or associated with data stored in the value vault 200 including merchant specific value programs 205 associated with each merchant for use in facilitating a financial transaction.

As indicated above, value programs 205 may include credits, cash back (207), gift cards (206), and coupons (209) of various monetary values ($5, $10, $20, etc., as shown in FIG. 3) that may be automatically made available to the user 102 for use toward the purchase of an item. Other value programs including award items (208) of various kinds including movie tickets, etc., as well as other loyalty or program incentives (210) such as insurance discounts may be automatically offered to the user 102.

One or more of the value programs 205 may be automatically made available and offered to the user 102 via the computer monitor during online access to the network 160, or the touch pad screen 304 or similar display device (not shown) at the time of checkout in a direct face-to-face financial transaction.

Once presented with the one or more value programs 205, the user 102 may accept all or any part of any one or more of the value programs 205 offered. Accordingly, if a twenty dollar gift card 206, coupon 209, or cash back 207 option is offered to the user 102, the user 102 may accept the full twenty dollar value, any portion of the twenty dollar value, or reject the offer in which case the offer is returned to the value vault 200 so that it may, in one embodiment, be made available to the user 102 at some later date.

If accepted by the user 102, value programs 205 that may have a designated monetary value such as a gift card, credit, coupon, or cash back award (206, 207, and 209) are generally used or applied to reduce the purchase price of an item.

Other value programs such as insurance offers, airfare discounts, or free gifts such as movie tickets, if accepted by the user, are acquired by the user 102 or redeemed toward the value program associated with the particular offer, and are not used toward reducing the purchase price of the item selected for purchase.

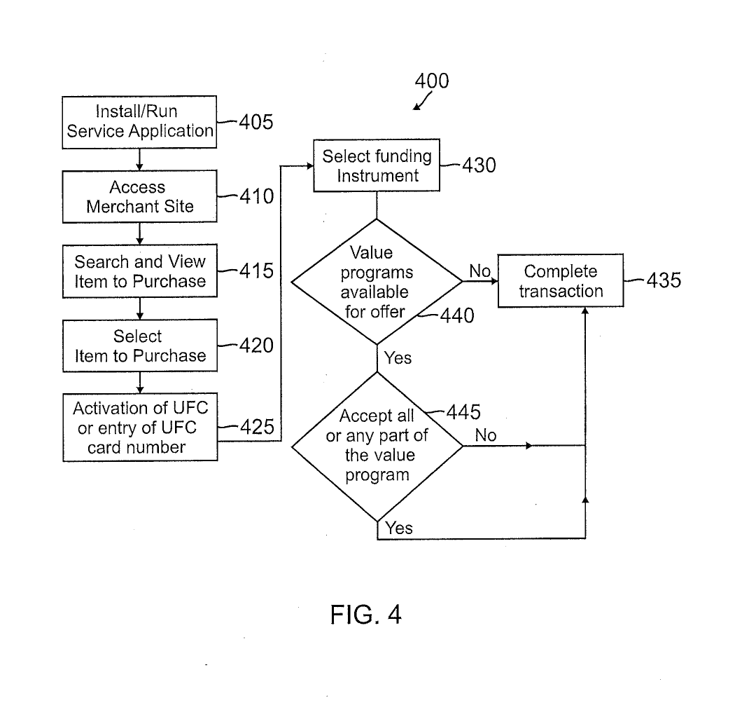

FIG. 4, shows a method 400 for administering a value vault for use in facilitating a financial transaction with reference to a user in accordance with one embodiment.

As previously discussed, the service application 126 allows the client device 120 to communicate with one or more of the merchant systems 140 via the network 160 to select items for purchase and further communicate with the payment provider system 180 to process online purchase requests and/or transactions for items selected for purchase.

In one embodiment, upon user instruction, the service application 126 may be installed and/or run on the client system 120 (block 405) to access at least one merchant website 141 via a related merchant system 140 (block 410) to search the accessed merchant website 141 and view one or more items for purchase (block 415). In one embodiment, upon installation, the user 102 may be prompted to establish a user account 184 with the payment provider system 180, wherein the user 102 may use the client system 120 to access the payment provider system 180 via the network 160. When establishing a user account 184, the user 102 may be asked to provide personal information, such as name, address, phone number, etc., and financial information, such as banking information, credit card information, etc.

Next, the user 102 may generate a purchase request for at least one item by selecting the at least one item (block 420) from the merchant's site 141. Methods of item selection (product and/or service) and communication of the purchase request including user information, merchant information, and selected item information to the payment provider system 180 for payment processing is generally well-known in the art. It should be appreciated by those skilled in the art that more than one item may be selected for purchase prior to completing the online purchase transaction as well as deciding whether to assign a single funding instrument or multiple funding instruments at the time of purchase. For example, a plurality of items may be selected and placed in a virtual shopping cart and then purchased in a single online purchase transaction.

At this point, the user 102 activates the universal funding card 101 (block 425), wherein the user 102 is given a choice of one or more funding instruments 105 to select from for use in purchasing the item (block 430).

Upon selection of one or more funding instruments 105, the user 102 may provide user identification or at least verify the user identification for a related user account 184 stored in payment provider system 180 so that authorization (acceptance or decline) for the financial transaction by the payment provider system 180 can be completed. Once proper user identification is provided and/or verified, the online purchase transaction may be completed (block 435) if no value programs 205 are available for offer to the user 102. On the other hand, if one or more value programs 205 are available, the one or more value programs 205 are automatically made available for offer to the user 102 (block 440). The user 102 may accept all or any part of the one or more value programs 205 offered or reject the one or more value programs 205 offered in their entirety (block 445).

In one instance, if the value program(s) offered are accepted, the purchase price of the selected item is reduced by an amount specified by the value program(s) 205. In another instance, if the value program(s) are accepted, the user 102 may use or redeem the value programs 205 for other product and/or services.

As shown in FIG. 4, regardless of whether no value programs are offered, value programs are offered and accepted, or value programs are offered and rejected the financial transaction for the purchase of an item is completed (block 435).

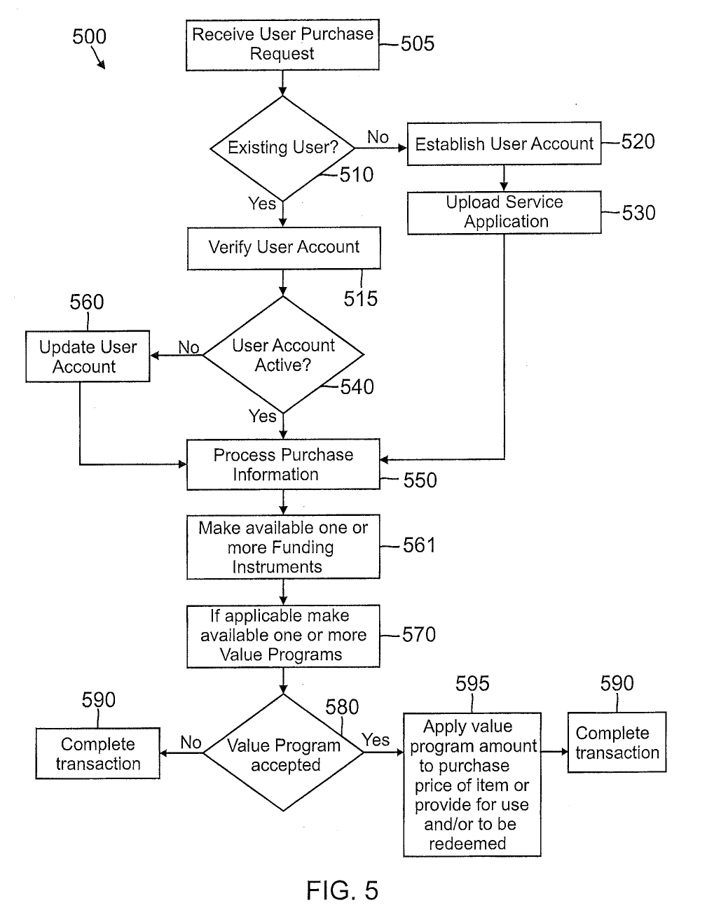

FIG. 5 shows a method 500 for administering a value vault for use in facilitating a financial transaction with reference to a payment processor device or provider server in accordance with one embodiment. As shown in FIG. 5, the payment provider system 180 receives a purchase request from the user 102 via the client system 120 (block 505). As previously discussed in reference to FIG. 4, the user 102 will typically begin an online transaction by selecting an item for purchase which initiates the user purchase request with the payment provider system 180.

Upon receiving the user purchase request (block 505), the payment provider system 180 may determine whether the user 102 is an existing user having an established user account 184 by, for example, checking a user account list in a user account database (block 510). If the user 102 does not have an established user account, then the payment provider system 180 may prompt the user 102 to establish a user account 184 by providing user information (block 520), and the payment provider system 180 uploads the service application 126 to the client system 120 so that the user 102 may install and run the service application 126 on client system 120 (block 530). Once the service application 126 is installed and run on the client system 120, the payment provider system server 180 processes the purchase information provided in the user purchase request (block 550).

Otherwise, if the user 102 is determined to be an existing user by the payment provider system 180 (block 510), then the payment provider system 180 verifies the user account and user identification information provided by user 102 in the user purchase request (block 515). For example, as previously discussed, the user 102 may be prompted to provide user identification to purchase any selected items and complete the online transaction. Next, the payment provider system 180 may determine if the user account is current and active (block 540). In some instances, a user's account information may need to be updated, and thus, the payment provider system 180 may prompt the user 102 to update user account information in the user account 184 for the user 102 (block 560). If the user account 184 is current and active, then the payment provider system 180 processes the purchase information in the user purchase request (block 550). It should be appreciated by those skilled in the art that the payment provider system 180 may cancel the online purchase transaction at any point in the process if it is determined, for example, that the user 102 enters wrong information.

The purchase information may include information related to the item selected for purchase, information related to the merchant providing the item selected for purchase, information related to the user including user account number, balance information, credit card information, etc. In one implementation, the payment provider system 180 may optionally access the merchant site 141 via the merchant system 140 to verify purchase information including verifying that the selected item is available (e.g., in stock), verifying the pricing information, verifying that the merchant account is up-to-date, etc.

The payment provider system 180 may then make available one or more funding instruments 105 to the user 102 for use in the purchase of the selected item (block 560). Once a funding instrument 105 is selected by the user 102, the payment provider system 180 may search the value vault 200 for one or more value programs 205 associate with the one or more funding instruments 105 and/or the merchant having the selected item for purchase. If one or more value programs 205 are available, the one or more value programs 205 are automatically made available or presented to the user 102 for acceptance or rejection (block 570).

If one or more of the value programs offered to the user 102 are rejected (block 580) the payment provider system server 180 may complete the financial transaction at the stated purchase price of the selected item (block 590). Alternatively, if all or any part of the one or more value programs 205 are accepted by the user 102 (block 580), the value amount of the one or more value programs 205 is used to reduce the purchase price of the item, or the one or more value programs 205 are provided to the user 102 for use and/or to be redeemed (block 595) and the financial transaction is completed by the payment provider system server 180 (block 590).

Final authorization (acceptance or decline) for the financial transaction by the payment provider system 180 may be completed by verifying user information and account 184 details stored in the payment provider system 180. Once proper user identification is provided and/or verified, the online purchase transaction may be completed (block 590). In one example embodiment, completing the purchase request may include redirecting the user 102 to a page on the merchant site 141 that confirms their purchase of the selected product to provide, for example, a receipt to the user 102.

In one embodiment, the value vault 200 described herein may be used as a central exchange, sale, or auction platform for the exchange, auction, trading, and/or buying and selling of gift cards 206 and/or other value programs 205 associated with the value vault 205.

In this regard, the payment provider system may maintain a database (value vault) of value programs 205, as well as, administer and process the sale and/or auction of gift cards 206 and/or other value programs 205 between network users 102. For example, a user 102 in possession of a $50 Target® gift card may desire to make the gift card available for purchase or trade to other users via the payment provider system 180. In one instance, such a sale, exchange, trade, or auction platform may include some breakage built-in to the system as the seller may be willing to accept less than the value of the value program 205 and/or the payment provider system may be compensated from the sale profits.

In contrast to open sale, trade, exchange, or auction networks where item values, conditions, warranty, etc., may be fraudulently represented and the speed of the transaction (offer, acceptance, payment, and delivery) may be comparatively slow, utilization of the payment provider system 180 as an intermediary to the sale, trade, exchange, or auction of a value program 205 provides a relatively greater level of built-in security, trust, and transaction speed.

As indicated above, in one embodiment, the universal funding card 101 may be used to access the user's merchant loyalty account for use in the purchase of an item. Likewise, a user's merchant loyalty account card may be used as an authorization for access to the user's various other accounts maintained by the payment provider system server 180.

In accordance with various embodiments of the invention, a computer device or system, such as devices 120, 140, 160, and 180 described herein and which may further include a personal computer and/or a network server, includes a bus or other communication mechanism for communicating information, which interconnects subsystems and components, such a as processing component (e.g., processor, micro-controller, digital signal processor (DSP), etc.), system memory component (e.g., RAM), static storage component (e.g., ROM), disk drive component (e.g., magnetic or optical), network interface component (e.g., modem or Ethernet card), display component (e.g., CRT or LCD), input component (e.g., keyboard), and cursor control component (e.g., mouse or trackball). In one implementation, disk drive component may comprise a database having one or more disk drive components.

In accordance with embodiments of the invention, the computer system performs specific operations by a processor executing one or more sequences of one or more instructions contained in a system memory component. Such instructions may be read into system the memory component from another computer readable medium, such as a static storage component or a disk drive component. In other embodiments, hard-wired circuitry may be used in place of or in combination with software instructions to implement the subject matter disclosed herein.

Logic may be encoded in a computer readable medium, which may refer to any medium that participates in providing instructions to the processor for execution. Such a medium may take many forms, including but not limited to, non-volatile media, volatile media, and transmission media. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments, execution of instruction sequences to practice the invention may be performed by computer system. In various other embodiments of the invention, a plurality of computer systems coupled by communication link (e.g., network 160 of FIG. 1, LAN, WLAN, PTSN, or various other wired or wireless networks) may perform instruction sequences to practice embodiments in coordination with one another.

The computer system may transmit and receive messages, data, information and instructions, including one or more programs (i.e., application code) through a communication link and a communication interface. Received program code may be executed by the processor as received and/or stored in disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Although the method(s)/step(s) are illustrated and described herein as occurring in a certain order, the specific order, or any combination or interpretation of the order, is not required. Obvious modifications will make themselves apparent to those of ordinary skill in the art, all of which will not depart from the essence of disclosed subject matter, and all such changes and modifications are intended to be encompassed within the appended claims.

1. A cell phone system, comprising:
a non-transitory memory storing instructions; and
one or more hardware processors coupled to the non-transitory memory and configured to read the instructions to cause the cell phone system to perform operations comprising:
determining one or more items identified based on at least one input received by the cell phone system;
in response to the one or more items identified, determining an activation of a universal funding card (UFC) accessible from a touch pad screen of the cell phone system;
in response to the activation of the UFC, displaying on the touch pad screen information of a plurality of cards associated with the UFC, wherein the information displayed indicates at least one card from the plurality of cards associated with a value program retrieved from a vault database;
receiving from the touch pad screen one or more touch inputs that indicates a selection of the at least one card associated with the value program; and
in response to the selection of the at least one card, displaying on the touch pad screen an indication of a transfer for the one or more items with the at least one card associated with the value program.

2. The cell phone system of claim 1, further comprising a network interface component, wherein the one or more hardware processors are configured to read the instructions to cause the cell phone system to perform further operations comprising:
determining a communication with a remote server based at least on the network interface component, wherein the remote server maintains the vault database; and
receiving data from the remote server that indicates the value program associated with the at least one card, wherein the value program is displayed on the touch pad screen based at least on the data received from the remove server.

3. The cell phone system of claim 2, wherein the vault database maintained by the remote server comprises a plurality of other value programs associated with the plurality of cards associated with the UFC.

4. The cell phone system of claim 1, wherein the UFC comprises a physical card with an optical reader, and wherein the UFC is activated based at least on a communication with the cell phone system and the optical reader.

5. The cell phone system of claim 1, wherein the UFC comprises a physical card with a radio frequency identification (RF ID) chip, and wherein the UFC is activated based at least on a communication with the cell phone system and the RF ID chip.

6. The cell phone system of claim 5, wherein the transfer for the one or more items with the at least on card associated with the value program is based at least on UFC information transmitted from the RF ID chip to a provider system.

7. The cell phone system of claim 1, wherein the value program retrieved from the vault database reduces an amount associated with the transfer for the one or more items.

8. The cell phone system of claim 1, wherein the value program retrieved from the vault database comprises one or more loyalty programs that reduces an amount associated with the transfer for the one or more items, and wherein displaying on the touch pad screen the information of the plurality of cards associated with the UFC comprises displaying the one or more loyalty programs.

9. A system, comprising:
a non-transitory memory storing instructions; and
one or more hardware processors coupled to the non-transitory memory and configured to read the instructions to cause the system to perform operations comprising:
receiving transfer data based on a transfer between a merchant terminal and a client system of a user, the transfer data indicates a universal funding card (UFC) of the user that is associated with a plurality of cards available to the user;
in response to receiving the transfer data, accessing a vault database to determine program data of one or more value programs that are applicable to the user with the plurality of cards of the UFC;
causing the client system to display the one or more value programs applicable to the user with the plurality of cards of the UFC;
in response to receiving an indication from the client system of one or more cards from the plurality of cards, determining the transfer with an amount based at least the one or more cards and at least one corresponding value program from the one or more value programs.

10. The system of claim 9, wherein the one or more processors is configured to read the instructions to cause the system to perform further operations comprising:
determining an association of the at least one value program with a particular merchant associated with the merchant terminal; and
storing the at least one value program with an identifier of the particular merchant in the vault database, wherein the vault database comprising the one or more value programs associated with one or more merchants.

11. The system of claim 9, wherein the one or more processors is configured to read the instructions to cause the system to perform further operations comprising:
receiving an indication from the client system of one or more items identified by the client system; and
in response to the indication of the one or more items identified, determining an activation of the UFC card, wherein the transfer with the amount is further based on the activation of the UFC card.

12. The system of claim 9, further comprising a network interface component, wherein the one or more processors is configured to read the instructions to cause the system to perform further operations comprising:
determining a communication with the client system based at least on the network interface component; and
sending the program data to the client system that indicates the one or more value programs associated applicable to the user with the plurality of cards of the UFC.

13. The system of claim 9, wherein the UFC comprises a physical card with an optical reader, and wherein the transfer with the amount is further based on a communication with the optical reader and the merchant terminal.

14. The system of claim 9, wherein the UFC comprises a physical card with a radio frequency identification (RF ID) chip, and wherein the transfer with the amount is further based on a communication with the RF ID chip and the merchant terminal.

15. A method comprising:
receiving, electronically by a processor of a payment provider server, transaction data during a purchase transaction between a merchant and a user of a client system, wherein the transaction data including a universal funding card (UFC) of the user that is associated with a plurality of funding instruments available to the user;
in response to the receiving the transaction data, accessing a database to determine data representing one or more value programs that are applicable to the user via the plurality of funding instruments associated with the UFC;
causing the client system to display the one or more value programs and the plurality of funding instruments associated with the UFC; and
in response to receiving an indication of a choice of one or more of the plurality of funding instruments by the user from the client system and a corresponding value program, causing funds from the corresponding value program and the one or more of the plurality of funding instruments to be used for the purchase transaction.

16. The method of claim 15, further comprising:
determining an association of the corresponding value program with the merchant; and
storing the corresponding value program with an identifier of particular merchant in the database, the database comprising the one or more value programs associated with one or more merchants.

17. The method of claim 15, further comprising:
receiving an indication from the client system of one or more items identified by the client system; and
in response to the indication of the one or more items identified, determining an activation of the UFC card, wherein the funds from the corresponding value program and the one or more of the plurality of funding instruments used based on the activation of the UFC card.

18. The method of claim 15, further comprising:
determining a communication with the client system based at least on a network interface component of the payment provider server; and
sending the data representing the one or more value programs to the client system such that the funds from the corresponding value program and the one or more of the plurality of funding instruments is used for the purchase transaction.

19. The method of claim 15, the UFC comprises a physical card with a radio frequency identification (RF ID) chip, wherein the funds from the corresponding value program and the one or more of the plurality of funding instruments is used for the purchase transaction based on a communication with the RF ID chip and the merchant terminal.

20. The method of claim 15, wherein the UFC comprises a physical card with a radio frequency identification (RF ID) chip, and wherein the funds from the corresponding value program and the one or more of the plurality of funding instruments is used for the purchase transaction based on a communication with the RF ID chip and the merchant terminal.
